(19) United States
(12) Patent Application Publication
(10) Pub. No.: US 2024/0234802 A9
(43) Pub. Date: Jul. 11, 2024

(54) ALL-SOLID-STATE BATTERY EQUIPPED WITH PRESSURIZING PAD LAYER TO INCREASE LIFESPAN

(71) Applicants: Hyundai Motor Company, Seoul (KR); Kia Corporation, Seoul (KR)

(72) Inventors: Young Jin Nam, Seoul (KR); Yong Guk Gwon, Hwaseong-si (KR); Jae Ho Shin, Seoul (KR); Yong Seok Choi, Seoul (KR); Min Sun Kim, Goyang-si (KR)

(21) Appl. No.: 18/450,888

(22) Filed: Aug. 16, 2023

(30) Foreign Application Priority Data
Oct. 21, 2022 (KR) 10-2022-0136350

(51) Int. Cl. H01M 10/0562; H01M 4/134; H01M 10/0585

(52) U.S. Cl. CPC H01M 10/0562; H01M 4/134; H01M 10/0585

(57) ABSTRACT

An all-solid-state battery having an increased lifespan is equipped with a pressure pad layer. More particularly, the all-solid-state battery includes a unit cell and a pressuring pad layer. The unit cell is composed of a cathode, an anode, and a solid electrolyte layer positioned between the cathode and the anode. The pressurizing pad layer is positioned on each side of the unit cell and includes a non-porous upper layer, a non-porous lower layer, and a porous core layer positioned between the non-porous upper layer and the non-porous lower layer.

The present application claims priority to Korean Patent Application No. 10-2022-0136350, filed Oct. 21, 2022, the entire contents of which is incorporated herein for all purposes by this reference.

### TECHNICAL FIELD

The present disclosure relates to an all-solid-state battery equipped with a pressurizing pad layer to increase a lifespan thereof.

### BACKGROUND

Rechargeable lithium-ion secondary batteries are used not only in small electronic devices such as mobile phones and laptops but also in large vehicles such as hybrid vehicles and electric vehicles. Accordingly, there is a need to develop a secondary battery having higher stability and energy density.

Existing lithium-ion secondary batteries are mostly composed of cells based on organic solvents (i.e., organic liquid electrolytes), so there are limitations in improving the stability and energy density of the existing secondary batteries.

On the other hand, all-solid-state batteries using inorganic solid electrolytes are based on a technology that excludes organic solvents, thereby allowing the manufacturing of cells in which the cathode and anode layers and the solid electrolyte between the cathode and anode layers are arranged in a safer and simpler form. The all-solid-state battery has recently been in the spotlight because of its high energy density per volume.

However, all-solid-state batteries can have a problem in that as charging and discharging proceed, each component may be deteriorated by contraction and expansion, thereby shortening the lifespan. In addition, all-solid-state batteries can further have electrolytes, electrodes, and current collectors, etc. that may also deteriorate due to local volume expansion resulting from lithium electrodeposition phenomenon inside a cell.

Therefore, there is a need for the development of a solid-state battery with improved volume expansion due to non-uniform lithium deposition in the cell under the above background.

### SUMMARY

An objective of the present disclosure is to provide an all-solid-state battery capable of suppressing volume expansion due to non-uniform lithium deposition.

The objective of the present disclosure is not limited to the objective mentioned above. The objectives of the present disclosure will become more apparent from the following description and will be realized by means and combinations thereof described in the claims.

The all-solid-state battery according to the present disclosure includes a unit cell having a cathode, an anode, and a solid electrolyte layer positioned between the cathode and the anode, and a pressurizing pad layer positioned on each side of the unit cell and including an upper layer, a lower layer, and a porous core layer positioned between the upper layer and the lower layer, wherein the upper layer and the lower layer are non-porous.

The unit cell may be configured such that a lithium electrodeposition layer is formed on the surface of the anode during discharge.

The core layer may be contracted by the lithium electrodeposition layer.

The core layer may have a porosity in a range of 15% to 85%.

The pressurizing pad layer may press the unit cell.

The pressurizing pad layer may include at least one material selected from the group consisting of a silicone-based material, a rubber-based material, a polymer material, and combinations thereof.

The unit cell may be configured such that a lithium electrodeposition layer is formed on the surface of the anode during discharge, and the thickness (A) of the pressurizing pad layer may satisfy the condition of Formula 1 below.

B≤A≤C [Formula 1]

Here, B is the thickness of the lithium electrodeposition layer, and C is the thickness of the unit cell.

The total thickness of the pressurizing pad layer may be in a range of 1 to 10 mm.

The thickness of the upper layer and the lower layer may be within 30% of the total thickness of the pressurizing pad layer.

The thickness of the core layer may be within 80% of the total thickness of the pressurizing pad layer.

The all-solid-state battery may further include a support stacked on the pressurizing pad layer.

In the all-solid-state battery according to the present disclosure, a pressurized pad layer including a porous structure on the surface of an electrode is applied such that pressure is applied to the unit cell, and thus the problem of shortening a lifespan thereof due to expansion can be effectively resolved.

According to the present disclosure, it is possible to obtain an all-solid-state battery in which lithium is uniformly deposited, and both durability and charge/discharge efficiency are improved by suppressing volume expansion caused by lithium deposition.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 is a schematic drawing showing an example cross-sectional view of an all-solid-state battery according to the present disclosure;

FIG. 2 is a schematic drawing showing an example cross-sectional view of an all-solid-state battery after discharging according to the present disclosure;

FIG. 3 is a schematic drawing illustrating an appearance of the altered pressurizing pad layer after discharging the all-solid-state battery according to the present disclosure;

FIG. 4 is a scanning electron microscope image showing an example cross-section of the anode current collector after charging in a conventional all-solid-state battery;

FIG. 5 is an example cross-sectional view of the anode part when the all-solid-state battery of the Comparative Example is charged;

FIG. 6 is an example cross-sectional view of the anode part when the all-solid-state battery of the Example is charged;

FIG. 7 is a plot illustrating a sample result of evaluating the charge/discharge performance of all-solid-state batteries according to Examples and Comparative Examples; and

FIG. 8 is a plot illustrating a sample pressure change according to the porosity of the core layer in the pressurizing pad layer.

### DETAILED DESCRIPTION

The above objectives, other objectives, features, and advantages of the present disclosure will be easily understood through the following preferred implementations in conjunction with the accompanying drawings. However, the present disclosure is not limited to the implementations described herein and may be embodied in other forms. Rather, the implementations introduced herein are provided so that the disclosed content may be thorough and complete, and the spirit of the present disclosure may be sufficiently conveyed to those skilled in the art.

The present disclosure relates to an all-solid-state battery having an increased lifespan by applying a pressurizing pad layer, and the configuration of the all-solid-state battery will be described in more detail as follows.

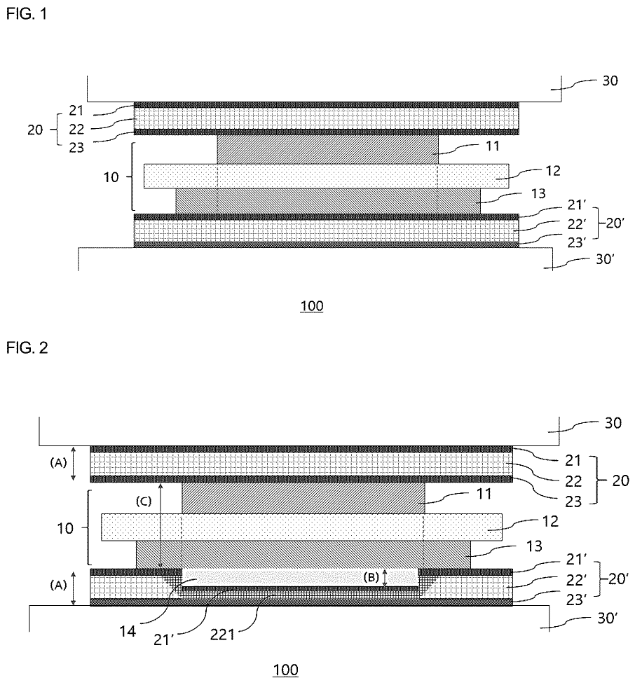

An all-solid-state battery, according to the present disclosure, will be described with reference to FIGS. 1 to 2 as follows. Here, FIG. 1 schematically shows a cross-sectional view of an all-solid-state battery according to the present disclosure. FIG. 2 schematically shows a cross-sectional view of an all-solid-state battery after discharging according to the present disclosure.

Referring to FIGS. 1 to 2, the all-solid-state battery 100, according to the present disclosure, includes a unit cell 10 having a cathode 11, an anode 13, and a solid electrolyte layer 12 positioned between the cathode 11 and the anode 13, and pressurizing pad layers 20 and 22′ positioned on both sides of the unit cell 10 and including a non-porous upper layer 21 and 21′, a non-porous lower layer 23 and 23′, and a porous core layer 22 and 22′ positioned between the upper layer 21 and 21′ and the lower layer 23 and 23′.

The all-solid-state battery 100 according to the present disclosure is characterized in that the pressurizing pad layers 20 and 20′ positioned on both sides of the unit cell 10 are applied.

Each component of unit cell 10 is not particularly limited in the components and functions, and any of those known in the art to which the present disclosure pertains may be used.

When charging the all-solid-state battery 10, lithium ions (Li⁺) move to the anode 13 and are stored as lithium metal (Li⁰). Conversely, during discharging, lithium metal (Li⁰) is converted into lithium ions (Li⁺), moves to the cathode 11, and is stored in the form of lithium oxide (Li₂O). That is, as the all-solid-state battery 100 is charged and discharged, the volume of the cathode 11 and the anode 13 repeats expansion and contraction, respectively.

In the process, solid state components such as the active material and the solid electrolyte included in the electrodes 11 and 13 are broken, or the contact between the electrodes 11 and 13 and the solid electrolyte layer 12 is weakened. In addition, as shown in FIG. 2, the unit cell 10 may generate a lithium electrodeposition layer 14 on the surface of the anode 13 during discharging.

On the other hand, in the all-solid-state battery according to the present disclosure, pressure may be applied to the unit cell 10 by applying the pressurized pad layers 20 and 20′, including the porous structure on the surfaces of the cathode 11 and the anode 13, thereby effectively solving a problem of shortening a lifespan thereof due to expansion.

Hereinafter, the pressurizing pad layers 20 and 20′ will be described in detail.

The pressurizing pad layers 20 and 20′ are stacked and positioned on the surfaces of cathode 11 and anode 13, respectively.

As shown in FIG. 1, the pressuring pad layer 20 may be positioned on the surface of the cathode 11, and the pressuring pad layer 20′ may be positioned on the surface of the anode 13.

First, since the pressurizing pad layer 20 on the surface of the cathode 11 and the pressurizing pad layer 20′ on the surface of the anode 13 have the same configuration, the pressurizing pad layer 20′ positioned on the surface of the anode 13 according to the present disclosure will be mainly described as follows.

The pressuring pad layer 20′ according to the present disclosure has a three-layer structure in which the lower layer 23′, the core layer 22′, and the upper layer 21′ are stacked in this order.

The material of the pressurized pad layer 20′ may be any elastic material capable of enduring the temperature of battery performance evaluation without limitation.

Specifically, the pressure pad layer 20′ can be made from one or more of a silicone-based material, a rubber-based material, or a polymer material. In some cases, the pressure pad layer 20′ may include at least one material selected from the group consisting of a silicone-based material, a rubber-based material, a polymer material, and combinations thereof. That is, the material of the upper layer 21′, the lower layer 23′, and the core layer 22′ may be at least one material selected from the group consisting of a silicone-based material, a rubber-based material, a polymer material, and combinations thereof.

The upper layer 21′ and the lower layer 23′ have a non-porous structure. In some implementations, the upper layer 21′ and the lower layer 23′ may have the same configuration.

The total thickness of the pressurizing pad layer 20′ may be in a range of 1 to 10 mm. More preferably, the total thickness of the pressure pad layer 20′ may be in a range of 1 to 5 mm.

In some cases, the thickness of the upper layer 21′ and the lower layer 23′ may be within 30% of the total thickness of the pressurizing pad layer.

Here, when the thickness of the upper layer 21′ and the lower layer 23′ exceeds 30% of the total thickness of the pressurizing pad layer, mechanical properties may be lowered, and thus a lithium expansion inhibitory effect may be lowered.

The thickness of the core layer 22′ may be within 80% of the total thickness of the pressurizing pad layer.

When the thickness of the core layer 22′ exceeds 80% of the total thickness of the pressure pad layer, it may be difficult to control uniform volume expansion.

Referring to FIG. 2, the thickness (A) of the pressurizing pad layer may satisfy the condition of Formula 1 below.

B≤A≤C [Formula 1]

Here, B is the thickness of the lithium electrodeposition layer 14, and C is the thickness of the unit cell 10.

Here, when the thickness (A) of the pressurizing pad layer is smaller than the thickness of the lithium electrodeposition layer (B), the volume expansion suppression effect may be reduced, and when the thickness (A) of the pressurized pad layer is greater than the thickness (C) of the unit cell, it may be difficult to realize energy density.

As such, when the pressurizing pad layer satisfying Formula 1 is applied, the adverse effect of volume expansion due to charging and discharging of the all-solid-state battery 100 can be effectively offset.

The core layer 22′ has a porous structure. Specifically, the core layer 22′ may be porous, having a porosity in a range of 15% to 85%. When the porosity of the core layer is less than 15%, the stress (pressure change) relaxation effect is insignificant, and when the porosity of the core layer is more than 85%, since there is no elasticity, the effect according to the present disclosure may not be achieved.

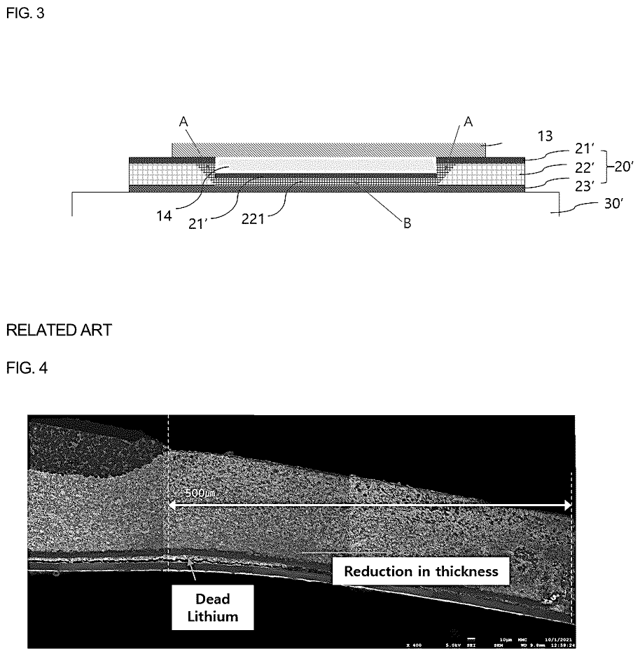

FIG. 3 schematically shows the appearance of the pressurizing pad layer 20′ changed after discharging the all-solid-state battery according to the present disclosure.

As shown in FIG. 3, it can be confirmed that the core layer 22′ is contracted by the lithium electrodeposition layer 14 generated on the surface of the anode 13 during discharging due to the porous structure. Accordingly, the core layer 22′ may include a contraction region 221 during discharging.

Referring to FIG. 3, the contraction region 221 is composed of an A region and a B region.

The region A provides a relief effect of the stress applied to the unit cell 10.

The region B is a region that is contracted in the pressurizing pad layer 20′ by the pressure of the lithium electrodeposition layer 14 generated during discharging. Accordingly, the pressure pad layer 20′ has the effect of suppressing the expansion of the unit cell 10 by applying a pressure opposite to the pressure to the lithium electrodeposition layer 14 to the unit cell 10.

In addition, in the pressurizing pad layer 20′ according to the present disclosure, as the charge amount of the solid-state battery 100 increases (i.e., SOC), the pressure applied to the pressurizing pad layer 20′ by the lithium electrodeposition layer 14 increases. As a result, the pressurizing pad layer 20′ has hard physical properties to suppress the generation of dead lithium in the A region. Here, SOC is an abbreviation of “State of Charge”, which literally means “state of charging”.

Meanwhile, FIG. 4 is a result of scanning electron microscope analysis of the cross-section of the current collector when SOC is performed 100 times in a conventional all-solid-state battery.

Referring to FIG. 4, it can be seen that dead lithium is deposited on the edge portion corresponding to region A with a length of about 500 μm on a conventional anode surface. This is because dead lithium is non-uniformly generated on the surface of the anode due to the occurrence of a step according to the thickness of the lithium electrodeposition layer generated after charging and the high pressure applied to the unit cell.

Therefore, in the all-solid-state battery according to the present disclosure, by applying a pressurizing pad layer including a porous structure on the surface of an electrode, pressure is applied to the unit cell, thereby effectively solving the problem of shortening a lifespan thereof due to expansion.

In addition, the all-solid-state battery 100 may further include supports 33 and 30′ stacked on the pressurizing pad layers 20 and 20′, respectively.

The supports 33 and 30′ are for supporting the pressurizing pad layers 20 and 20′, and their components and functions are not particularly limited, and any of those known in the art to which the present disclosure pertains may be used.

Hereinafter, another implementation of the present disclosure will be described in more detail through Examples. The following examples are merely illustrative to help the understanding of the present disclosure, and the scope of the present disclosure is not limited thereto.

### Example

An all-solid-state battery was prepared by applying the pressurizing pad layer shown in FIG. 1. Specifically, as the type of unit cell, an anodeless all-solid-state battery was applied. A pressurizing pad layer was stacked on both surfaces of the unit cell, respectively.

A silicone pad was used for the upper and lower layers of the pressurizing pad layer. The core layer of the pressurizing pad layer used a porous pad having elasticity. In this case, the pressurizing pad layer has a total thickness in a range of 2 to 3 mm, and the porosity of the porous pad was 40%.

### Comparative Example

Unit cells made of the same material as the implementation were used, but 2 mm thick silicone pads were respectively stacked on both sides of the unit cells instead of the pressurizing pad layers stacked on both sides of the unit cells. In this case, a silicone pad having a porosity of 0% was used.

### Experimental Example 1—Scanning Electron Microscope (SEM) Analysis

First, a scanning electron microscope analysis was performed on the all-solid-state batteries according to Example and Comparative Example.

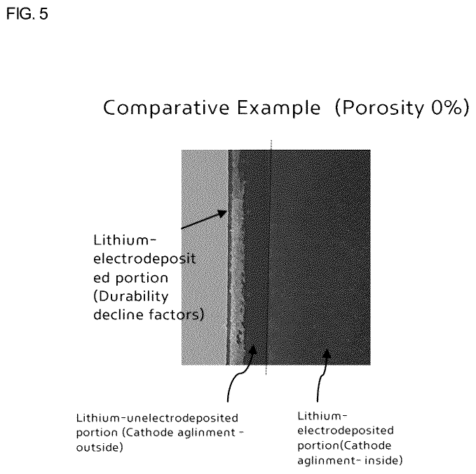

FIG. 5 is the disassembled and analyzed cross-section of the anode part when the all-solid-state battery of the Comparative Example is charged.

Referring to FIG. 5, it was confirmed that lithium was irregularly precipitated. This causes irregularly precipitated lithium to decrease the durability of solid-state batteries.

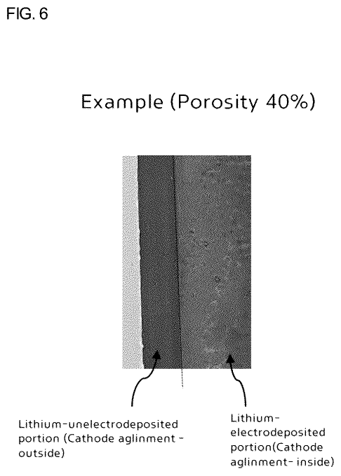

Subsequently, FIG. 6 shows the disassembled and analyzed cross-section of the anode part when the all-solid-state battery of the above Example is charged.

Referring to FIG. 6, it can be confirmed that lithium is uniformly precipitated. This was effective in suppressing the generation of edge lithium compared to the Comparative Example by applying the pressurizing pad layer, including the porous structure, to the surface of the unit cell.

### Experimental Example 2—Evaluation of Charging and Discharging Characteristics

The charging and discharging performance of the all-solid-state batteries according to the above Example and Comparative Example were evaluated. The charge/discharge test was conducted under conditions in a range of 1 mA/cm² to 3.3 mAh/cm².

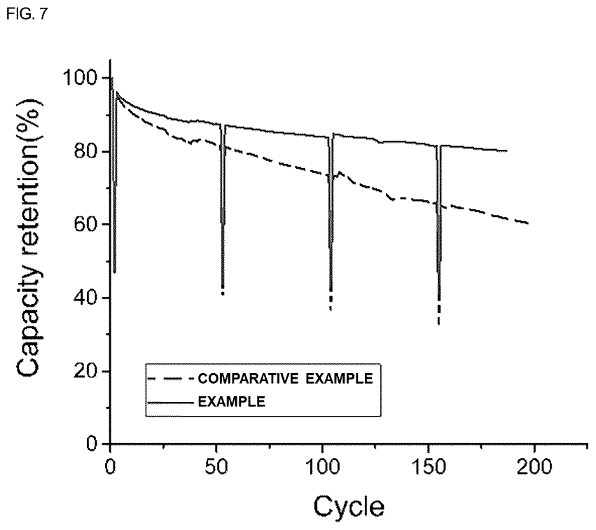

FIG. 7 is a result of an evaluation of the charge/discharge performance of all-solid-state batteries according to Examples and Comparative Examples.

Referring to FIG. 7, it can be seen that the charge/discharge performance of the all-solid-state battery, according to the Example, is superior to that of the Comparative Example.

Therefore, in this disclosure, lithium is uniformly deposited, and an all-solid-state battery with improved durability and charge/discharge efficiency is obtained by suppressing volume expansion due to lithium deposition.

### Experimental Example 3 Evaluation of Porosity Characteristics

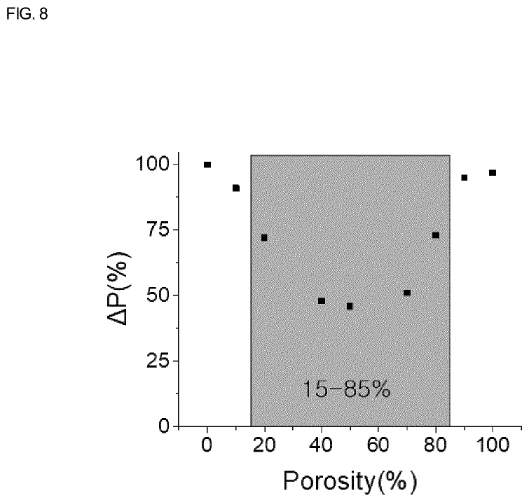

Next, the pressure changes characteristics according to the porosity of the core layer applied to the pressurizing pad layer were confined. The results are shown in FIG. 8.

Referring to FIG. 8, when the porosity of the core layer is in a range of 15% to 85%, it may be seen that the amount of pressure change inside the pressurizing pad layer is most suitable.

Although the implementation of the present disclosure has been described above, it will be understood by those skilled in the art that the present disclosure may be implemented in other specific forms without changing the technical spirit or essential features thereof. Therefore, it should be understood that the implementations described above are illustrative in all respects and not restrictive.

What is claimed is:

1. An all-solid-state battery comprising:
a unit cell comprising a cathode, an anode, and a solid electrolyte layer positioned between the cathode and the anode; and
a pressurizing pad layer positioned on each side of the unit cell and comprising an upper layer, a lower layer, and a porous core layer positioned between the upper layer and the lower layer,
wherein the upper layer and the lower layer are non-porous.

2. The all-solid-state battery of claim 1, wherein the unit cell is configured such that a lithium electrodeposition layer is formed on a surface of the anode during discharge.

3. The all-solid-state battery of claim 2, wherein the core layer is configured to be contracted by the lithium electrodeposition layer.

4. The all-solid-state battery of claim 1, wherein the core layer has a porosity in a range of 15% to 85%.

5. The all-solid-state battery of claim 1, wherein the pressurizing pad layer is configured to press the unit cell.

6. The all-solid-state battery of claim 1, wherein the pressurizing pad layer comprises at least one material selected from the group consisting of a silicone-based material, a rubber-based material, a polymer material, and combinations thereof.

7. The all-solid-state battery of claim 1, wherein the unit cell is configured such that a lithium electrodeposition layer is famed on a surface of the anode during discharge, and the pressurizing pad layer has a thickness A that satisfies the condition of Formula 1:
B≤A≤C,
wherein B is the thickness of the lithium electrodeposition layer, and C is the thickness of the unit cell.

8. The all-solid-state battery of claim 1, wherein the pressurizing pad layer has a total thickness in a range of 1 to 10 mm.

9. The all-solid-state battery of claim 1, wherein the pressurizing pad layer is arranged in a horizontal direction above and below the unit cell based on the cross section of the unit cell.

10. The all-solid-state battery of claim 1, wherein an area of the pressurizing pad layer is larger than areas of each of the anode, the cathode, and the solid electrolyte layer.

11. The all-solid-state battery of claim 1, wherein the thickness of each of the upper and lower layers is within 30% of the total thickness of the pressurizing pad layer.

12. The all-solid-state battery of claim 1, wherein the thickness of the core layer is within 80% of the total thickness of the pressurizing pad layer.

13. The all-solid-state battery of claim 1, further comprising a support stacked on the pressurizing pad layer.
